(19) United States
(12) Patent Application Publication
(10) Pub. No.: US 2025/0348320 A1
(43) Pub. Date: Nov. 13, 2025

(54) COMPUTING DEVICES WITH INSTRUCTION QUEUES AND PROCESSING-ELEMENT ARRAY CONTROLLERS

(71) Applicant: UNTETHER AI CORPORATION, Toronto (CA)

(72) Inventors: Dustin T. GRIESDORF, Kitchener (CA); Jonathan Andrew SCOBBIE, Toronto (CA); Reza HOJABROSSADATI, Port Moody (CA)

(21) Appl. No.: 18/661,145

(22) Filed: May 10, 2024

(51) Int. Cl. G06F 9/38; G06F 15/80

(52) U.S. Cl. CPC G06F 9/3887; G06F 15/8023

(57) ABSTRACT

An example device includes single instruction, multiple data (SIMD) processing elements arranged in arrays. Array controllers are connected to the arrays of processing elements to control the arrays of processing elements to execute instructions in a SIMD fashion. An instruction queue is connected to an array controller. The instruction queue queues a sequence of instructions and dequeues the sequence of instructions to the array controller. Multiple instruction queues may be used. A main controller provides sequences of instructions to the instruction queues.

### BACKGROUND

Computing devices that use single instruction, multiple data (SIMD) architecture are capable of performing a large number of parallel operations. Spatial architecture may provide for fast and efficient parallel processing but may suffer from a tradeoff between instruction flexibility and control efficiency.

### BRIEF DESCRIPTION OF THE DRAWINGS

FIG. 1 is a diagram of an example single instruction, multiple data (SIMD) computing device.

FIG. 2 is a diagram of an example SIMD computing device with instruction queues and array controllers.

FIG. 3 is a diagram of an example SIMD computing device with multiple main controllers.

FIG. 4A is a diagram of an example main controller with a single thread that generates multiple sequences of instructions for multiple instruction queues.

FIG. 4B is a diagram of an example main controller with multiple threads that generate multiple sequences of instructions for multiple instruction queues.

FIG. 4C is a diagram of an example main controller with one thread for each instruction queue.

FIG. 5 is a diagram of an example processing element.

### DETAILED DESCRIPTION

This disclosure provides techniques for controlling computing devices with single instruction, multiple data (SIMD) architecture, which may also be termed at-memory compute or spatial architecture. Described herein are methodologies that use instruction queues and related controllers to handle sequences of instructions destined for subsets (arrays) of the normally large number of processing elements used in such computing devices. The techniques discussed herein can help mitigate problems resulting from the tradeoff between instruction flexibility and control efficiency and can reduce occurrences of blocking that might otherwise arise.

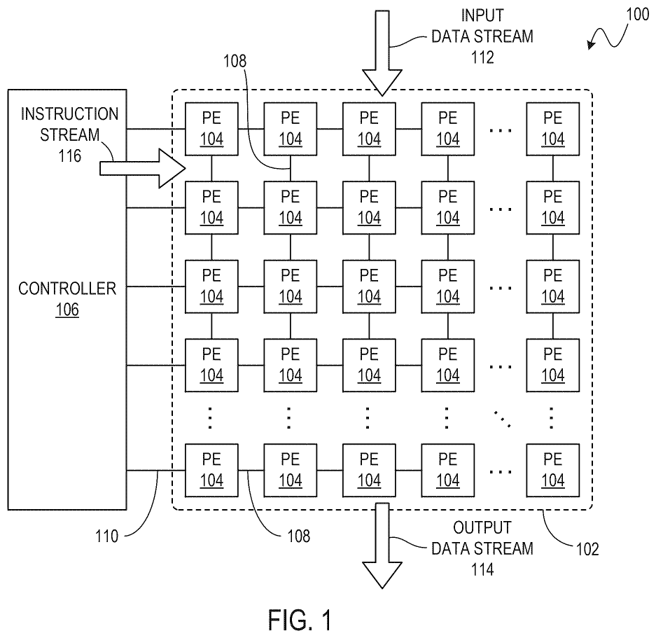

FIG. 1 shows an example computing device 100 that includes an array 102 of processing elements 104 controlled by a controller 106. The computing device 100 is configured for single instruction, multiple data (SIMD) operation. The computing device 100 may be termed a SIMD computing device, at-memory computing device, or spatial-architecture computing device. U.S. Pat. No. 11,881,872, which is incorporated herein by reference, may be referenced for additional details concerning SIMD computing devices, such as the device 100.

The array 102 of processing elements 104 (without the controller 106) may be referred to as a “bank.” Alternatively, the controller 106 and array 102 may together be referred to as a “bank.” Multiple banks may be connected together to form a computing device with higher processing capacity.

The processing elements or PEs 104 may be logically and, optionally, physically arranged in a two-dimensional grid. Such an array 102 may be considered to have rows and columns.

Each processing element 104 includes circuitry to perform one or more operations, such as addition, multiplication, bit shifting, multiplying accumulations, etc. For example, each processing element 104 may include a multiplying accumulator and supporting circuitry. A processing element 104 may additionally or alternatively include an arithmetic logic unit (ALU) or similar.

Each processing element 104 includes or is connected to working memory dedicated to that processing element 104. Shared memory may also be provided. A processing element 104 may be connected with one or more neighboring processing elements 104 to share data and/or instructions. Processing element interconnections 108 may be provided in the row direction, the column direction, or both.

The controller 106 is connected to a subset of processing elements 104, such by interconnections 110, which may include a bus and may additionally include a direct connection to an outermost row or column of PEs 104 or several outermost rows or columns of PEs 104. The controller 106 is a processor (e.g., microcontroller, etc.) that may be configured with instructions to control the connected processing elements 104.

The controller 106 controls the connected processing elements 104 to perform the same operation on different element data contained in each processing element 104. For example, each processing element 104 may hold two arbitrary numbers, X and Y, and the controller 106 may instruct the processing elements 104 to each multiply (or add, subtract, etc.) their individual values of X and Y at the same time.

The controller 106 may further control loading/retrieving of data to/from the processing elements 104, control the communication among processing elements 104, and/or control other functions for the processing elements 104. Any suitable number of controllers 106 may be provided to control the processing elements 104. Controllers 106 may be connected to each other for mutual communications. Controllers 106 may be arranged in a hierarchy, in which, for example, a main controller controls sub-controllers, which in turn control subsets of processing elements 104.

The array 102 of processing elements 104 may operate on an input stream of data 112, which may be marched through the processing elements 104 via interconnections 108 and undergo simultaneous operations by the processing elements 104 to generate a resulting output stream of data 114. This may occur with data movement in one direction of the array 102, as illustrated, or may involve more complex movement of data among processing elements 104.

The controller 106 may provide a stream of instructions 116 to the processing elements 104 via the interconnections 110 and may command the processing elements 104 to execute the instructions in a simultaneous/parallel manner on their respective elements of data.

During operation, any of the processing elements 104 may be blocked if there is no data ready or no instruction provided. A block processing element 104 may block one or more other processing elements 104 that require a result from the block processing element 104. Also, it may be the case that the specific computation specified by the instruction dictates the time it takes.

Hence, for a stream of instructions 116, the total time to execute may vary. Often, there is data dependency between processing elements 104 or subsets of processing elements. Further, when multiple processing-element arrays 102 or devices 100 are connected to operate together, the total amount of time to execute instructions across such processing-element arrays 102 or devices 100 may become highly interdependent.

Instruction flexibility with a large number of processing elements 104 is relatively low since all processing elements 104 must execute the same instruction at the same time. However, a large number of processing elements 104 results in increased control efficiency. In contrast, a small number of processing elements 104 increases instruction flexibility at the expense of decreased control efficiency.

Accordingly, dividing the control of the array 102 of processing elements 104 among multiple layers of controllers 106 and introducing a queue for instructions may give the computing device 100 or similar devices increased flexibility and performance while reducing control efficiency cost.

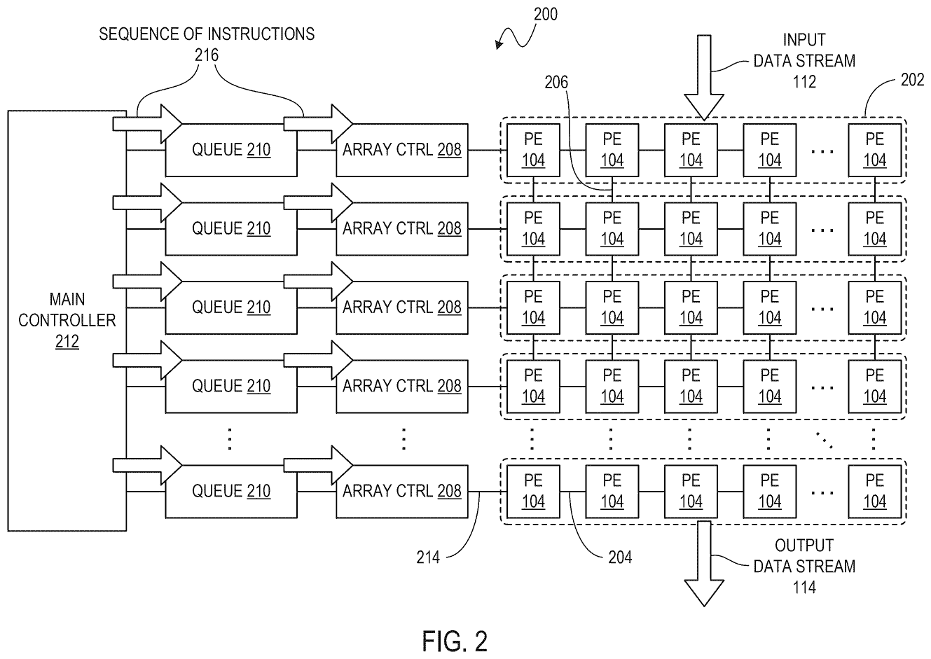

FIG. 2 shows an example computing device 200 that implements at least some of the above concepts to provide increased flexibility and performance while reducing control efficiency cost.

The device 200 includes a plurality of SIMD processing elements 104 arranged in arrays 202. An array 202 may be one dimensional (e.g., a row or column) or two dimensional. Processing elements 104 have interconnections 204 (e.g., a bus and/or direct connections) within the same array 202 and may also have interconnections 206 between arrays 202. Any suitable number of processing elements 104 may be used. In various examples, the processing elements number in the hundreds or thousands. In various examples, multiple devices 200 may be connected together to operate in conjunction.

The device 200 further includes a plurality of array controllers 208, a plurality of instruction queues 210, and a main controller 212. Each array controller 208 controls a respective array 202 of processing elements 104 and is provided with instructions by a respective instruction queue 210. Any suitable number of arrays 202, array controllers 208, and instruction queues 210 may be used.

Each array controller 208 is connected to a respective array 202 of processing elements 104 by, for example, interconnections 214 (e.g., a bus and/or direct connections) with one or more processing elements 104 in the array 202. An array controller 208 is a processor (e.g., microcontroller, etc.) that is configured to command the processing elements 104 of the connected array 202 to execute instructions in SIMD fashion. That is, the controller 208 commands the processing elements 104 of the array 202 to perform simultaneous execution of each instruction of the sequence 216. The array controllers 208 are not required to coordinate execution with each other. Rather, the array controllers 208 may each operate independently of one another.

Each instruction queue 210 may be a buffer such as a first in, first out (FIFO) buffer. An instruction queue 210 is connected to a respective array controller 208 and is configured to queue the respective sequence of instructions 216. Each instruction queue 210 dequeues the respective sequence of instructions 216 to the connected array controller 208.

The main controller 212 is a processor (e.g., microcontroller, etc.) that is connected to the instruction queues 210. The main controller 212 is configured to provide the different sequences of instructions 216 to the instruction queues 210. The main controller 212 may execute one or more processing threads, and a given thread may generate one or more sequences of instruction 216.

In an example of operation, input data is provided to the arrays 202 of processing elements 104, for example, by way of an input data stream 112. The main controller 212 generates various different sequences of instructions 216 for the computation on the input data stream. The sequences of instruction 216 may be configured to have different arrays 202, or even different processing elements 104 within an array 202, perform certain computations to achieve an overall result. For example, a first array 202 may have each of its processing elements 104 add two numbers and a second array 202 may have each of its processing elements multiply the results from the first array with another number.

Continuing with the example operation, the main controller 212 enqueues instructions of each sequence 216 with at a respective queue 210. Each array controller 208 dequeues instructions of the sequence 216 from the connected queue 210 and commands the processing elements 104 of the connected array 202 to execute each instruction. The arrays 202 of processing elements 104 so commanded ultimately generate a result, which may take the form of an output stream of data 114.

Operation may be continuous, such that an input stream of data 112 flows through the arrays 202 of processing elements 104 to emerge as an output stream of data 114, with the shape of the flow and rate thereof being controlled by the dissemination of the sequences of instructions 216 through the various queues 210.

If a particular array controller 208 is blocked from executing an instruction (e.g., its connected array 202 is waiting for output from another array 202), the main controller 212 may continue to fill the associated queue 210. In this way, the queues 210 reduce the likelihood that the main controller 212 becomes blocked merely because some of the processing elements 104 are blocked. If an instruction queue 210 is full, then the main controller 212 is blocked, but only for that queue 210. The main controller 212 may continue to fill other instruction queues 210.

If an instruction queue 210 becomes empty, then the connected array controller 208 is blocked due to there being no instruction for the associated array 202 of processing elements 104. However, other queues 210 may still contain instructions and thus it is unlikely that all array controller 208 will be blocked at the same time.

As such, it should be apparent that the device 200 mitigates the cost of the tradeoff between instruction flexibility and control efficiency. The instruction queue 210 and respective array controllers 208 reduce the likelihood that a relatively large number of the processing elements 104 become blocked. Blocking also becomes more manageable, in that if one array 202 is blocked, other arrays 202 of processing elements 104 may continue to operate normally.

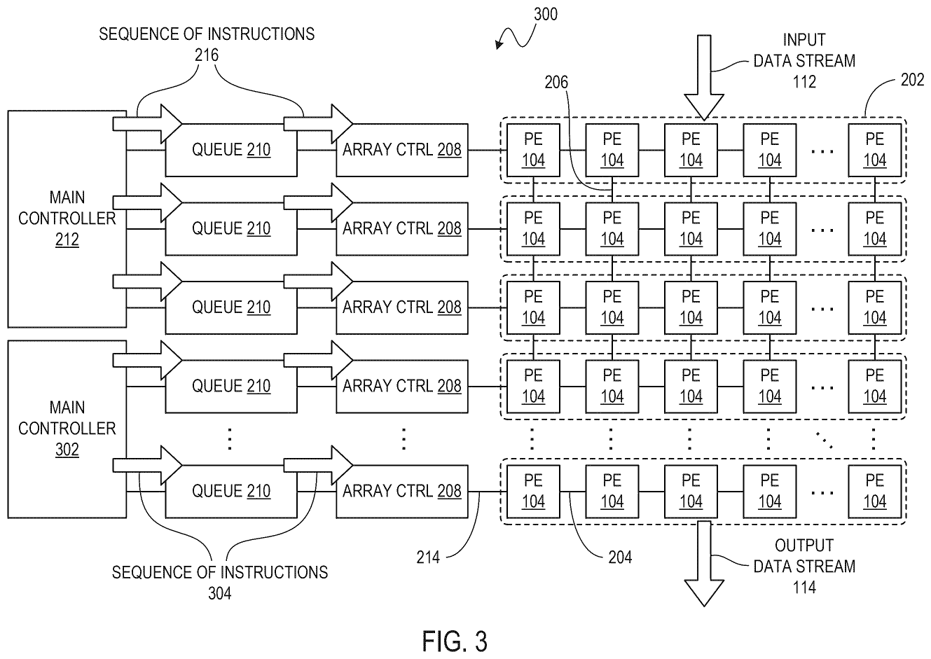

FIG. 3 shows another example computing device 300. The computing device 300 is similar to the computing device 200 discussed above and only differences will be discussed in detail. Like terminology and/or like reference numerals denote like components, and the above description may be referenced for details not repeated here. In various examples, multiple devices 300 may be connected together to operate in conjunction.

The device 300 includes arrays 202 of processing elements 104, array controllers 208, instruction queues 210, and multiple main controllers 212, 302.

The main controllers 212, 302 are processors (e.g., microcontroller, etc.). In this example, two main controllers 212, 302 are provided. In other examples, any suitable number of main controllers may be provided.

A first main controller 212 is configured to provide first sequences of instructions 216 to a first subset of the instruction queues 210. A second main controller 302 is configured to provide second sequences of instructions 304 to a second subset of the instruction queues 210. Accordingly, the same arrangement of processing elements 104 may be controlled by multiple main controllers 212, 302 with the stability and predictability afforded by the instruction queues 210 and array controllers 208.

The main controllers 212, 302 may be in communication to coordinate operations. Additionally or alternatively, the main controllers 212, 302 may be connected and subordinate to another controller that coordinates operations of the main controllers 212, 302.

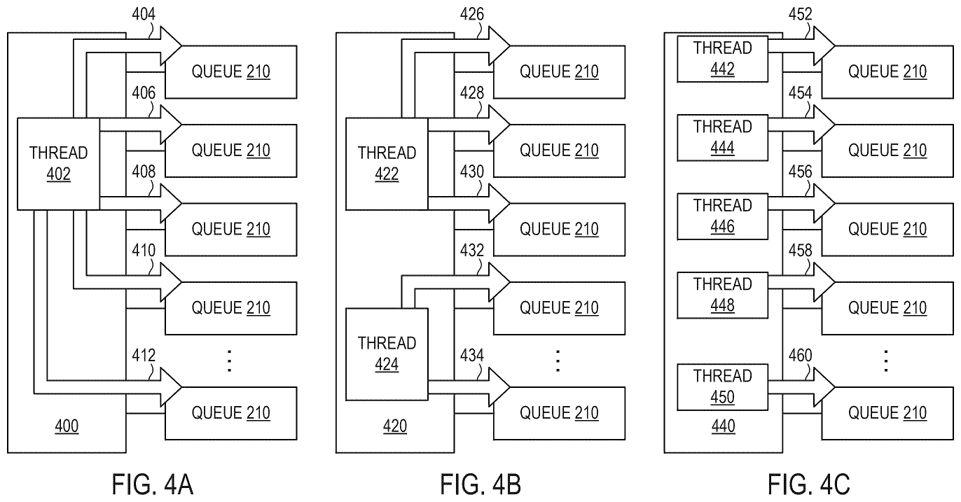

As mentioned above, a main controller may process one or more threads of code execution. A thread may generate instructions for processing elements. The relationship between threads and generated sequences of instructions may be established to meet various implementation requirements. FIGS. 4A-4C show several examples.

FIG. 4A shows an example main controller 400 with a single thread 402 that generates multiple sequences of instructions 404, 406, 408, 410, 412 for multiple instruction queues 210. This thread-to-instruction sequence relationship may be considered a one-to-many relationship. The main controller 400 may be used with any of the computing devices discussed above.

The instruction queues 210 are connected to array controllers 208, which in turn are connected to arrays 202 of processing elements 104, as discussed above. The above description may be referenced for details not repeated here.

The main controller 400 is configured to process one thread that generates and provides the same or different sequences of instructions 404, 406, 408, 410, 412 to the instruction queues 210. In various examples, the sequences of instructions 404, 406, 408, 410, 412 all contain different instructions, some of the sequences of instructions 404, 406, 408, 410, 412 are the same and some are different, or all sequences of instructions 404, 406, 408, 410, 412 contain the same instructions.

FIG. 4B shows an example main controller 420 with multiple threads 422, 424 that generate multiple sequences of instructions 426, 428, 430, 432, 434 for multiple instruction queues 210. This thread-to-instruction sequence relationship may be considered a many-to-many relationship. The main controller 420 may be used with any of the computing devices discussed above.

The instruction queues 210 are connected to array controllers 208, which in turn are connected to arrays 202 of processing elements 104, as discussed above. The above description may be referenced for details not repeated here.

The main controller 420 is configured to process multiple threads 422, 424 that generate and provide sequences of instructions 426, 428, 430, 432, 434. Any suitable number of threads may be used. In this example, each thread 422 and 424 provides multiple sequences of instructions 426, 428, 430 and 432, 434. In various examples, the sequences of instructions 426, 428, 430, 432, 434 all contain different instructions, some of the sequences of instructions 426, 428, 430, 432, 434 are the same and some are different, or all sequences of instructions 426, 428, 430, 432, 434 contain the same instructions.

FIG. 4C shows an example main controller 440 with multiple threads 442, 444, 446, 448, 450 that each generates one sequence of instructions 452, 454, 456, 458, 460 a respective instruction queue 210. This thread-to-instruction sequence relationship may be considered a one-to-one relationship. The main controller 440 may be used with any of the computing devices discussed above.

The instruction queues 210 are connected to array controllers 208, which in turn are connected to arrays 202 of processing elements 104, as discussed above. The above description may be referenced for details not repeated here.

The main controller 440 is configured to process multiple threads 442, 444, 446, 448, 450 that generate and provide sequences of instructions 452, 454, 456, 458, 460. In this example, a thread-to-sequence ratio of one-to-one is used. In various examples, the sequences of instructions 452, 454, 456, 458, 460 all contain different instructions, some of the sequences of instructions 452, 454, 456, 458, 460 are the same and some are different, or all sequences of instructions 452, 454, 456, 458, 460 contain the same instructions.

It should be noted that the examples of FIGS. 4A-4C also apply to multiple main controllers, such as discussed with respect to FIG. 3. Each of multiple main controllers may be implemented as any of the controllers 400, 420, 440 discussed above.

With regard to the main and array controllers discussed herein, a controller may be processor that implements a reduced instruction set computer (RISC) architecture, such as a RISC-V microarchitecture or similar.

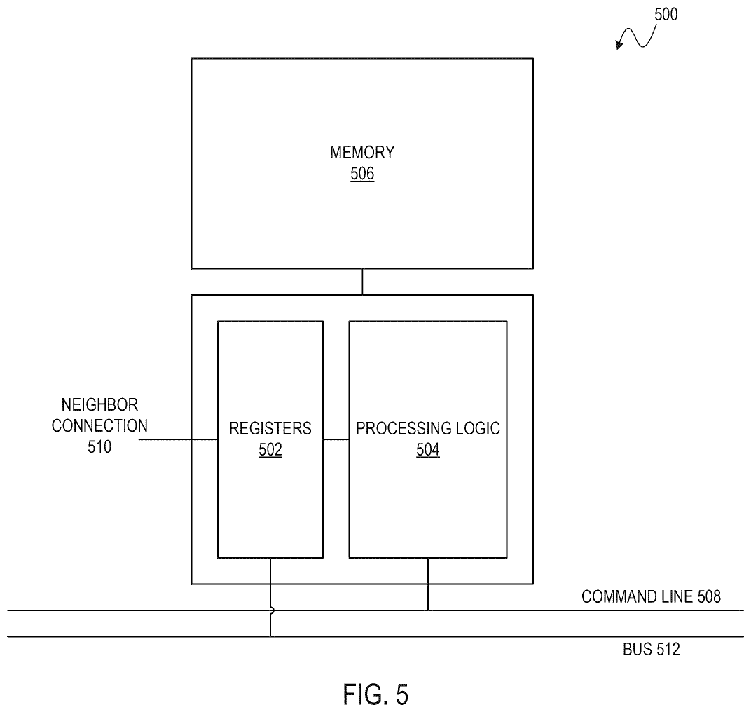

FIG. 5 shows an example processing element 500 that may be used as a processing element 104 in the above examples. The processing element 500 includes registers 502, processing logic 504, and memory 506. The processing element 500 is connected to a command line 508 that is connected to other processing elements in an array and an array controller (see above examples), so that the array controller may command all the processing elements 500 of the array to perform the same operation at the same time.

The processing element 500 may have a direct connection 510 to one or more neighbor processing elements 500 to directly share information. For example, the processing element 500 may be connected to one, two, three, or more neighbor processing elements 500 in any of four directions (up, down, left, and right on the page) when a grid-like array is used. The processing element 500 may be connected to a bus 512 for sharing of information to/from neighbor processing elements 500 or with an array controller (see above examples). The processing element 500 may be connected to a network-on-chip (NOC) to support sharing of information.

In this example, the registers 502 store information, such as operands, to be used by the processing logic 504, which may include an ALU, a multiplying accumulator, or similar processing logic. The memory 506 may be random-access memory (RAM) and may be configured to provide data to the registers, the processing logic, or both.

In operation, the processing logic 504 is provided with data from any one or combination of the memory 506, the neighbor connection 510, and the bus 512. The same occurs for the processing elements 500 of an array. Then, the array controller asserts a command (e.g., an opcode) on the command line 508 and the processing logic 504 of all processing elements 500 of the array performs the indicated operation on its data.

The processing element 500 is simplified for sake of explanation. The above indicated US patent may be referenced for further details.

It should be recognized that features and aspects of the various examples provided above can be combined into further examples that also fall within the scope of the present disclosure. In addition, the figures are not to scale and may have size and shape exaggerated for illustrative purposes.

1. A device comprising:
a plurality of single instruction, multiple data (SIMD) processing elements, the plurality of processing elements arranged in arrays of processing elements;
a plurality of array controllers, each array controller connected to an array of processing elements and configured to control the array of processing elements to execute instructions in a SIMD fashion;
a plurality of instruction queues, each instruction queue connected to an array controller, each instruction queue configured to queue a sequence of instructions and dequeue the sequence of instructions to the array controller; and
a main controller configured to provide sequences of instructions to the plurality of instruction queues.

2. The device of claim 1, wherein the main controller is configured to process one thread to provide the sequences of instructions.

3. The device of claim 1, wherein the main controller is configured to process a plurality of threads to provide the sequences of instructions.

4. The device of claim 3, wherein the main controller is configured to provide a sequence of instructions from one thread to one instruction queue.

5. The device of claim 3, wherein the main controller is configured to provide a sequence of instructions from one thread to multiple instruction queues.

6. The device of claim 1, wherein the main controller is a first main controller, the device further comprising a second main controller, wherein:
the first main controller is configured to provide first sequences of instructions to a first subset of the plurality of instruction queues; and
the second main controller is configured to provide second sequences of instructions to a second subset of the plurality of instruction queues.

7. The device of claim 6, wherein:
the first main controller is configured to process a first plurality of threads to provide the first sequences of instructions to the first subset of the plurality of instruction queues; and
the second main controller is configured to process a second plurality of threads to provide the second sequences of instructions to the second subset of the plurality of instruction queues.
